(19) United States
(12) Patent Application Publication
(10) Pub. No.: US 2020/0390285 A1
(43) Pub. Date: Dec. 17, 2020

(54) HERB GRINDER SYSTEM

(71) Applicant: Paul Martinez Galaviz, Buckley, WA (US)

(72) Inventor: Paul Martinez Galaviz, Buckley, WA (US)

(21) Appl. No.: 16/437,497

(22) Filed: Jun. 11, 2019

(51) Int. Cl. A47J 42/14; A47J 42/38

(52) U.S. Cl. CPC A47J 42/14; A47J 42/38

(57) ABSTRACT

An improved herb grinder system is described. Some implementations can include an herb grinder designed to keep ground material from drying out by providing moisture to an interior area of the grinder, where the moisture is delivered via packets or other suitable devices to keep the ground material in a moist environment. In some implementations, the grinder is modular to permit various aspects or configurations to be modified and adjusted for optimal performance of ground material storage. The herb grinder system can provide storage times that can vary from a few hours to days or longer by maintaining or increasing moisture levels to help preserve the quality of ground material.

### RELATED APPLICATIONS

This application claims the benefit of U.S. Provisional Application No. 62/683,901, entitled “Improved Herb Grinder” filed on Jun. 12, 2018, which is incorporated herein by reference in its entirety.

### FIELD

Embodiments relate generally to herb grinders, and more particularly, to an improved herb grinder system, method and retrofit top to grind herbs and maintain or increase the moisture content of the ground herbs or other material.

### BACKGROUND

A typical grinder works by receiving herb into a chamber having cutting teeth in the upper and lower sections. The herb is placed in the grinder. The user rotates the grinder to grind the herb. The ground herb material then falls through small holes in between the teeth. The ground herb collects in the lower chamber and is ready for use.

There is also a smaller screen that sifts smaller particles and collects them in a lower chamber beneath the herb chamber. Some conventional grinders also have blunt squared tops on the cutting teeth, which can make it difficult to close the lid and start the grinding process because the teeth must pierce through the herb in order to close the lid. This requires force to use and start the rotation process, which is the action that grinds the herb. Also, conventional grinder designs may not provide a way to maintain or add moisture to the ground up herbs (e.g., in a manner similar to that provided by a cigar humidor).

Once the material is ground and it falls through into the storage portion, it will start to become dry and result in a harsh tasting experience. This wastes material and costs money.

In view of the foregoing, it is clear that these traditional systems and methods leave room for more optimal approaches. A need may exist for a grinder that can maintain a desired moisture level or increase moisture content of ground material, which can result in an improved user experience in enjoying the ground material.

Some implementations were conceived in light of the above needs, problems and limitations, among other things.

### SUMMARY

Some implementations include various features that may be practiced alone or in combination. In combination, some implementations offer advantages in maintaining or increasing moisture levels in ground up herb material.

One aspect of the disclosed subject matter is an upper chamber, which is in addition to and attached on top of the herb chamber. In some implementations, in contrast to a conventional grinder lid, which may simply have grinding teeth on an inside of the lid, some implementations of the disclosed subject matter include additional holes on the underside underneath and provide and additional chamber above the holes to hold a moisture pack or other suitable moisture providing device.

The upper chamber has provisions for maintaining apertures in a first position (e.g., closed locked position) while grinding, so no ground herb material can migrate through the holes during the grinding process into the upper chamber where the moisture media is contained, and a second position (e.g., open aperture position) in which moisture from the upper chamber is permitted to be transmitted to the lower portions of the grinder to maintain or increase moisture levels in the ground material.

In some uses, instead of a moisture pack, the user could use an aromatic oil pack or other aromatic or scented device to infuse other essences, flavors or scents into the herbs while being stored in the grinder. The aromatic oil or essence packs can be used in combination with a moisture pack or other media.

The upper chamber when in the open position will allow moisture to flow through the holes and into the lower chambers where the ground herb material is held until needed. In addition to being open or closed, the apertures in the upper chamber can be set to an adjustable amount of opening to permit an amount of moisture migrating to the ground material into the lower sections or chambers to be controlled.

Some implementations may include a removable screen which can be replaced with various types of screen material or mesh densities/sizes (e.g., in microns), or even a solid membrane to prevent any of the material or moistened air to further migrate downward into the lower chamber. This would allow the lower chamber to be used to store other things, such as tools and other useful items.

Some implementations can utilize any type of moisture absorbing material that can be charged with moisture in a first environment (e.g., a manufacturing environment) and then, upon use in the grinder, will release moisture back into the air, thereby raising the humidity and moisture levels in the container in which it is held. The packets could be sold separately from the grinder as refills. Water itself could even be used with the proper membrane to prevent direct contact with the ground herb materials, which would result in oversaturated or wet material. Separation of the moisture media and herb material is somewhat important.

In the current configuration, the grinder can function as a storage mechanism for ground material that maintains proper humidity levels.

In a basic configuration, and without adding moisture packs or other moisture additive devices, the grinder will function similar to most conventional grinder designs, but with an enhanced cutting tooth design, which incorporates slightly angled tips to pierce through the herb making it easier to close the lid to start the grinding process.

In another version the upper section containing the cutting teeth and the moisture chamber could be made to fit existing grinders already on the market as a retrofit lid or upper portion to allow for all the benefits of the proposed invention as an aftermarket option for existing grinders.

### BRIEF DESCRIPTION OF THE DRAWINGS

FIG. 1 shows an exploded view of an example grinder system in accordance with some implementations.

FIG. 2 shows a cut away isometric view of the parts of a disclosed grinder assembled in the closed position in accordance with some implementations.

### DETAILED DESCRIPTION

Exemplary embodiments are described below. Reference is made to the examples in a non-limiting sense. They are provided to illustrate more broadly applicable aspects of the present invention. Various changes may be made to the invention described and equivalents may be substituted without departing from the true spirit and scope of the invention. In addition, many modifications may be made to adapt the disclosed subject matter to a contemplated design, particular situation, within the spirit or scope of the disclosed subject matter. All such modifications are intended to be within the scope of the disclosed subject matter and/or claims. For instance, a threaded mechanical connection might be shown in the drawings but other means of mechanical connection might also be used. A threaded connection was chosen for ease of illustration and is not intended to be limiting.

The drawings illustrate an exemplary embodiment of an herb grinder 10 with an additional chamber 20 added to hold moisture providing media in order to maintain a desired or optimal humidity level, raise a humidity level, or rehydrate dry ground herb. More generally, there are multiple open or closed positions to allow minimal or maximum amounts of air flow from the upper moisture containing chamber 20 to the lower chamber 30 where the ground herb material is held for use. The advantage being optimal enjoyment of the herb and no loss of money due to dried out herb material that may have typically been discarded in the past with conventional grinders lacking moisture control features.

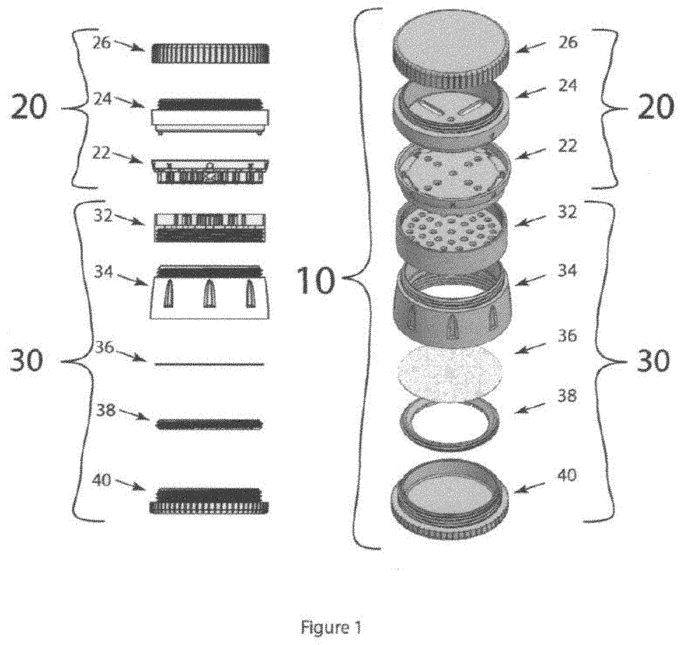

Turning to FIG. 1, it shows a grinder assembly 10 which includes the additional upper moisture chamber assembly 20 and lower chamber 30.

Typical grinders have just two chambers, one to hold the ground herb material (e.g., similar to 34) and the other chamber (e.g., similar to 40) that is below the first one to hold the finer particles that fall through a sifting screen 36. The two chambers are separated by sifting screen 36.

Additionally the sifting screen 36 is designed so it can be removed and replaced with other mesh ratings, sizes or densities for finer filtration of the ground herb material. The sifting screen 36 can be retained with locking ring 38 or similar means. Then the lower storage chamber 40 is attached.

The cutting ring 32 which contains teeth on the top as well as holes, then mates to herb chamber 34. The cutting ring 32 mates to the index grinder 22 which contains cutting teeth and holes designed to mate with cutting ring 32 to grind the herb. As the herb is ground, it falls through the apertures in the lower part of the cutting ring 32.

The moisture chamber 24 has holes in the bottom to allow air flow down through the index grinder 22, the cutting ring 32, the herb chamber 34, the sifting screen 36 and finally into the lower storage chamber 40.

The upper section 20 can be configured in many ways, moisture chamber 24 being shallow or deep or of a larger diameter if it is circular, to hold more or less moisture media at a time.

It is possible to have moisture chamber 24 in either a fully closed position, to allow no airflow, as well as no herb to migrate upward into the moisture chamber 24 when in the grinding process. Equally moisture chamber 24 can be in a fully open or partially open position to adjust the airflow for maximum or minimum into the lower section 30.

Some implementations can include a plurality of position settings for the upper chamber apertures. The positions can be marked with indexing identifier marks to facilitate closed, open, or partially or variably open positions.

In another embodiment, the chambers 20 and 30 would be larger (or smaller) in both diameter and depths to increase the amount of herb material that could be ground and or stored for later use. The exterior could also be in any shape, round, square, octagon, etc. The lid 26 closes the moisture chamber 24 and provides for a sealing means, which can be airtight.

In some implementations, the cutting teeth on cutting ring 32 and index grinder 22 may be designed to be more pointed or sharp to pierce through the herb and make it easier to close and initiate the rotational grinding process.

In some implementations, the upper section 20 could be made dimensionally to fit one or more existing grinders to provide a retrofit grinder lid or top with moisture control features. Thus, customers using other existing grinders could retrofit an existing grinder with the disclosed upper section 20 to permit a retrofitted existing grinder to provide the benefits of humidity and moisture control without the need to replace an entire existing grinder.

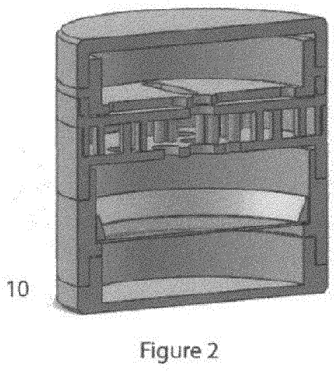

FIG. 2 shows a cut away isometric view of the parts of a disclosed grinder assembled in the closed position. The mating of the cutting teeth is visible as are the holes in which ground herb falls through into the lower section 30.

The exterior is shown completely smooth, but exterior embellishments could be added by machining or casting into the finished product. These added embellishments would not interfere with the functionality of the grinder.

It is, therefore, apparent that there is provided, in accordance with the various embodiments disclosed herein, an improved herb grinder with feature to store and maintain humidity of ground material stored therein.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A grinder comprising:
an upper chamber having a lid, a moisture chamber and an index grinder; and
a lower chamber having a cutting ring, an herb chamber, a sifting screen, and a lower storage chamber.

2. The grinder of claim 1, wherein moisture chamber includes one or more apertures between the moisture chamber and the index grinder that can be closed or open.

3. The grinder of claim 1, wherein moisture chamber includes one or more apertures between the moisture chamber and the index grinder that can be closed or open a varying amount.

4. The grinder of claim 1, further comprising a moisture additive disposed in the moisture chamber.

5. The grinder of claim 4, wherein the moisture additive includes a moisture packet have a liquid solution absorbed into material within the moisture packet.

6. The grinder of claim 5, wherein the moisture packet further includes one or more of an essential oil, an aromatic additive, a flavoring, an essence, or a fragrance.

7. The grinder of claim 1, further comprising a locking ring disposed between the sifting screen and the lower storage chamber.

8. The grinder of claim 1, wherein the sifting screen includes apertures.

9. The grinder of claim 1, wherein the sifting screen is solid.

10. A retrofit grinder lid comprising:
a lid;
a moisture chamber; and
an index grinder.

11. The retrofit grinder lid of claim 10, wherein moisture chamber includes one or more apertures between the moisture chamber and the index grinder that can be closed or open.

12. The retrofit grinder lid of claim 10, wherein moisture chamber includes one or more apertures between the moisture chamber and the index grinder that can be closed or open a varying amount.

13. The retrofit grinder lid of claim 10, further comprising a moisture additive disposed in the moisture chamber.

14. The retrofit grinder lid of claim 13, wherein the moisture additive includes a moisture packet have a liquid solution absorbed into material within the moisture packet.

15. The retrofit grinder lid of claim 14, wherein the moisture packet further includes one or more of an essential oil, an aromatic additive, a flavoring, an essence, or a fragrance.

16. A method to grind and store ground material in a moisture-controlled environment, the method comprising:
providing herb material;
placing the herb material into a grinder having an upper chamber having a lid, a moisture chamber and an index grinder, and a lower chamber having a cutting ring, an herb chamber, a sifting screen, and a lower storage chamber;
placing a moisture additive into the moisture chamber;
grinding the herb material; and
opening one or more apertures between the moisture chamber and the lower chamber to permit moisture from the moisture additive to reach ground material in the lower chamber.

17. The method of claim 16, wherein moisture chamber includes one or more apertures between the moisture chamber and the index grinder that can be closed or open.

18. The method of claim 16, wherein moisture chamber includes one or more apertures between the moisture chamber and the index grinder that can be closed or open a varying amount.

19. The method of claim 16, wherein the moisture additive includes a moisture packet have a liquid solution absorbed into material within the moisture packet.

20. The method of claim 16, wherein the moisture packet further includes one or more of an essential oil, an aromatic additive, a flavoring, an essence, or a fragrance.
